(19) United States
(12) Patent Application Publication
(10) Pub. No.: US 2022/0053807 A1
(43) Pub. Date: Feb. 24, 2022

(54) Wild Ginseng into Honey

(71) Applicant: Yong Yi, Centreville, VA (US)

(72) Inventor: Yong Yi, Centreville, VA (US)

(21) Appl. No.: 16/997,967

(22) Filed: Aug. 20, 2020

(51) Int. Cl. A23L 21/25; A23L 33/105

(52) U.S. Cl. CPC A23L 21/25; A23V 2002/00; A23L 33/105

(57) ABSTRACT

This disclosure relates generally to cutting wild ginseng in small pieces and placing them inside the honey. Overtime all the nutrition from the wild ginseng will be soaked into the honey. As Longer its inside, it will be more effective. Later we can eat it directly or make tea with honey.

### BACKGROUND

### Field of the Invention

The present invention relates to cutting wild ginseng in small pieces and placing them inside the honey. Overtime all the nutrition from the wild ginseng will be soaked into the honey. Later we can eat it directly or make tea with honey.

Aspects of the present invention relate more particularly to the field of cutting wild ginseng in small pieces. None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### Description of the Related Art

Similar patent issued to SUI DAYUN; XIE YONG; YUAN XIAOPING CN105193889A. The invention relates to a preparation for processed ginseng flowers and also provides a preparation method of the preparation. The efficacy of the ginseng flowers is improved after being processed with the method. Besides, the cold and cool property of the ginseng flowers is changed, the irritation of gingers can be changed by adding processed honey, and the taste is improved. Effective ingredients of the ginseng flowers can be completely retained and can be absorbed better in human bodies. The purposes of detoxicity and synergy can be achieved if the ginseng flowers in the same dosage are taken, and the preparation and the preparation method play an important role in protection of rare medicinal resources.

CN104587429A Ginger juice and honey impregnated American ginseng preparation and preparation method thereof. The invention provides a ginger juice and honey impregnated American ginseng preparation and further provides a preparation method of the ginger juice and honey impregnated American ginseng preparation. The American ginseng is impregnated with fresh ginger juice and honey, thus the American ginseng is improved in the efficacies of replenishing qi, strengthening healthy qi and moistening dryness, is changed in cold nature and is suitable for more people to eat. The effective components of the American ginseng are totally retained, and the actual use amount of the American ginseng is reduced correspondingly under the condition that the American ginseng preparation of same dose is used. Therefore, the use amount of medicinal materials is reduced under the condition that the clinical treatment effect of the American ginseng preparation is not reduced at least. The reduction of the use amount of medicinal materials is of great importance to the protection of medicinal resources.

EP2981178A1 COMPOSITION FOR MAKING A TEA BEVERAGE OR HERBAL AND VEGETABLE BROTHS. The present invention relates to an infusion product for making a beverage, more specifically to a plant-based composition for making a beverage, and to a herbal and/or vegetable composition or bouquet garni. The plants are fruits, herbs, medicinal plants, tea, vegetables and/or spices. The invention further relates to a method for producing said compositions or infusion product, its use for making a (tea) beverage, and a (tea) beverage so obtained. Further, the present invention relates to a fiber-web, preferably a tea bag, made from said fruits, herbs, medicinal plants, tea, vegetable and/or spices.

Inventor Jean Marie VasicekGerald Scott Shurman patent number US20170318846A1. The comprehensive result of the present invention contains raw honey, bee pollen, and/or manually collected pollen. The pollens are frozen to prevent spoilage. Upon collecting all of the desired pollens, the pollens are mixed together and thoroughly blended with raw honey to create a product, with extended shelf life, containing a known variety of pollens.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The primary desirable object of the present invention is to provide cutting wild ginseng into small pieces.

While a specific embodiment has been shown and described, many variations are possible. With time, additional features may be employed. The particular shape or configuration of the platform or the interior configuration may be changed to suit the system or equipment with which it is used.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

While a specific embodiment has been shown and described, many variations are possible. With time, additional features may be employed. The particular shape or configuration of the platform or the interior configuration may be changed to suit the system or equipment with which it is used. For thousands of years, ginseng has been widely recognized and used as a precious tonic. However, according to recent studies in China and the West, the most precious part of the nutritional value of ginseng is not the ginseng root, but the ginseng flower bud.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

1. The present invention comprising:
cutting wild ginseng in small pieces and placing them inside the honey;
Overtime all the nutrition from the wild ginseng will be soaked into the honey.
